(19) United States
(12) Patent Application Publication
(10) Pub. No.: US 2006/0013073 A1
(43) Pub. Date: Jan. 19, 2006

(54) Analog timepiece for full day indication

(76) Inventor: Chiou-Haun Lee, Taichung City (TW)

Correspondence Address: CHARLES E. BAXLEY, ESQ., 90 JOHN STREET, THIRD FLOOR, NEW YORK, NY, 10038, US

(21) Appl. No.: 10/895,200

(22) Filed: Jul. 19, 2004

(51) Int. Cl. G04B 19/00

(52) U.S. Cl. 368/223

(57) ABSTRACT

An analog timepiece includes a dial, which has equally spaced 24 marks marked on the face thereof corresponding to 24 hours of a day, the 24 marks including a first series of 12 marks arranged in a day zone and a second series of 12 marks arranged in a night zone, hands turning on the face of the dial to indicate time, and a clock hand driving unit that turns the hands on the face of the dial to indicate time, the clock hand driving unit including a pulse generating unit that outputs 0.5 pulse/sec signal, and a motor controlled by the 0.5 pulse/sec signal to turn the hands on the face of the dial to indicate time.

### BACKGROUND OF THE INVENTION

1. Field of the Invention

The present invention relates to an analog timepiece and more particularly, to a power-saving analog timepiece, which indicates day/night status.

2. Description of the Related Art

A conventional timepiece (clock or timepiece) uses mechanical means or a physical method to measure time. A mechanical timepiece drives hour hand, minute hand and/or second hand to move on a dial, thereby indicating time. Following fast development of electronic technology, various electronic and semi-electronic timepieces have been disclosed, and have appeared on the market. An electronic timepiece indicates time by digits.

Further, an analog watch uses clock hands to indicate time and an electronic circuit to control a clock hand driving motor to move clock hands via a clock gear set. The electronic circuit of an analog timepiece according to the prior art, as shown in FIGS. 6 and 7, comprises a pulse generator 50 that outputs 1 pulse/sec signal. Therefore, the motor 51 moves the second hand one step per sec. Each time the second hand moved 60 steps, the minute hand moves one step. The face of the dial is divided into 12 hour zones respectively marked with a respective hour numeral. One run of the hour hand on the face corresponds to 12 hours (one half day). This design of analog timepiece does not indicate day/night status. There are electronic timepieces with a voice function to report time and day/night status. These electronic timepieces consume much electric energy.

### SUMMARY OF THE INVENTION

The present invention has been accomplished under the circumstances in view. It is therefore the main object of the present invention to provide an analog timepiece, which indicates day/night status. It is another object of the present invention to provide an analog timepiece, which saves consumption of electric energy. To achieve these and other objects of the present invention, the analog timepiece comprises a dial, which has equally spaced 24 marks marked on the face thereof corresponding to 24 hours of a day, the 24 marks including a first series of 12 marks arranged in a day zone and a second series of 12 marks arranged in a night zone, hands turning on the face of the dial to indicate time, and a clock hand driving unit that turns the hands on the face of the dial to indicate time. The clock hand driving unit comprises a pulse generating unit that outputs 0.5 pulse/sec signal, a motor controlled by the 0.5 pulse/sec signal to turn the hands on the face of the dial to indicate time, and a clock gear set coupled between the motor and the at least one hand. The face of the dial is divided into two equal halves, namely, the first half for day zone and the second half for night zone. The first series of 12 marks and the second series of 12 marks are respectively arranged in the first half and second half of the face of the dial. The motor is controlled to turn the second hand one step/2 sec. Therefore, one half turn of displacement of the minute hand represents 60 minutes; one half turn of displacement of the hour hand represents 12 hours. Further, The pulse generating unit comprises a pulse generator that generates 1 pulse/sec signal, and a dividing-by-2 dividing circuit electrically connected to the pulse generator and adapted to divide the 1 pulse/sec signal into the 0.5 pulse/sec signal.

### BRIEF DESCRIPTION OF THE DRAWINGS

FIG. 1 is a block diagram of a clock hand driving unit for use in an analog timepiece according to the present invention.

FIG. 2 is a detailed circuit diagram of a part of the clock hand driving unit according to the present invention.

FIG. 3 is schematic drawing showing the output pulse signal of the clock hand driving unit shown in FIG. 1.

FIG. 4A shows one indication example of the analog timepiece according to the present invention.

FIG. 4B shows another indication example of the analog timepiece according to the present invention.

FIG. 5A shows still another indication example of the analog timepiece according to the present invention.

FIG. 5B shows still another indication example of the analog timepiece according to the present invention.

FIG. 6 is a block diagram of a clock hand driving unit for use in an analog timepiece according to the prior art.

FIG. 7 is a schematic drawing showing the output pulse signal of the clock hand driving unit shown in FIG. 6.

### DETAILED DESCRIPTION OF THE PREFERRED EMBODIMENT

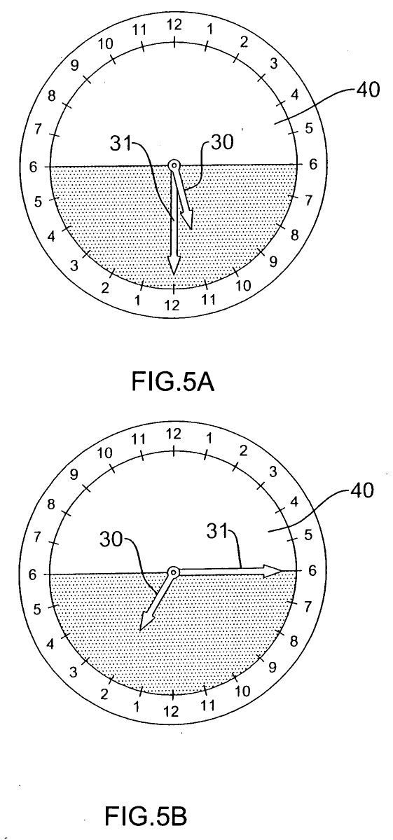

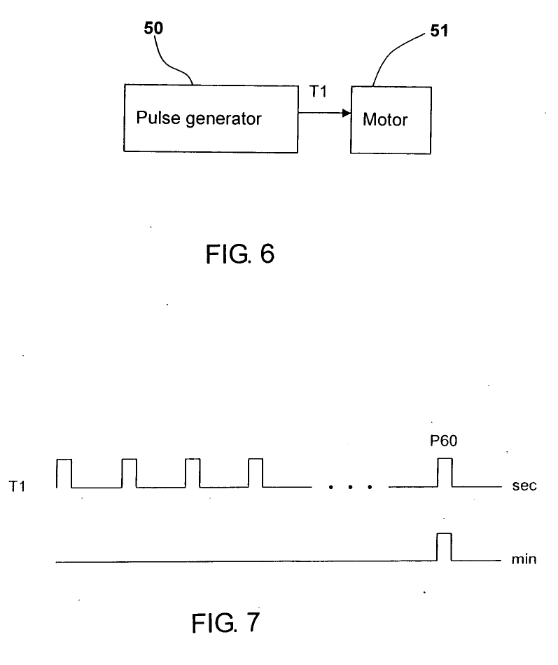

Referring to FIG. 5A, an analog timepiece in accordance with the present invention uses a clock hand driving unit 10 (not shown) to move the second hand one step per every two seconds, and the dial 40 has two sets of hour numerals equiangularly spaced along the border area for 24-hour indication and is equally divided into a day zone and a night zone. Therefore, the analog timepiece indicates current time and day/night status.

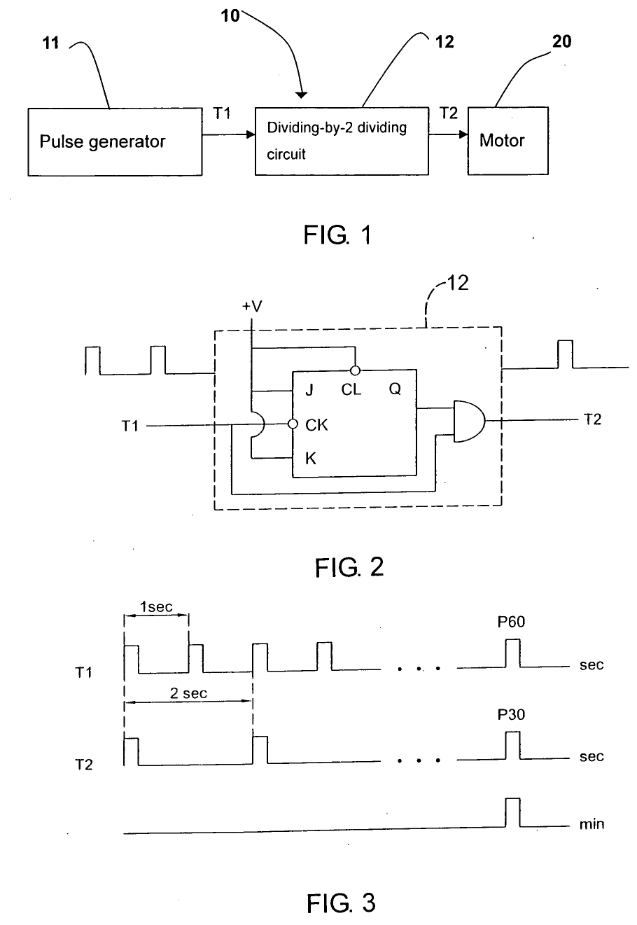

Referring to FIGS. 1 and 2, the clock hand driving unit 10 of the analog timepiece comprises a pulse generator 11, a dividing-by-2 dividing circuit 12, and a motor 20. The pulse generator 11 generates 1 pulse/sec signal, which is divided into 0.5 pulse/section signal by the dividing-by-2 dividing circuit 12. The dividing-by-2 dividing circuit 12 is comprised of a JK flip-flop and a logic device (see FIG. 2). The motor 20 is controlled by output signal of the dividing-by-2 dividing circuit 12 to move the second hand (not shown), minute hand 31 and hour hand 30 through a pinion and a clock gear set (not shown).

Referring to FIG. 3, the output signal of the pulse generator 11 that controls the second hand is set to be one count per 2 seconds. When the 120^{th} pulse (P120) generated, the second hand completes one run, and the clock gear set moves the minute hand ahead for one step. Therefore, when the minute hand 31 moves one half run, it represents one hour, and at this time the hour hand 30 is moved to a next hour numeral on the dial 40.

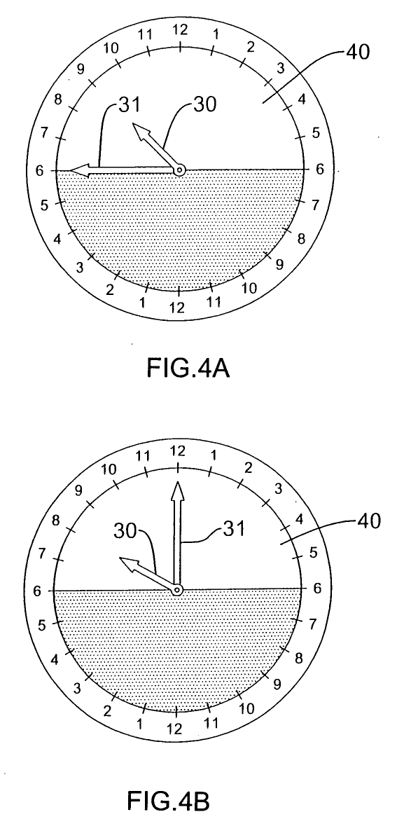

FIGS. 4A, 4B, 5A and 5B show two different indication examples of the present invention. In FIG. 4A, the hour hand 30 is aimed at the hour numeral “9” within the day zone on the dial 40, and the minute hand 31 is aimed at the hour numeral “6” at the left side between the day zone and the night zone on the dial 40. Therefore, the time measured is 9:30 AM. In FIG. 4B, the hour hand 30 is aimed at the hour numeral “8” within the day zone on the dial 40, and the minute hand 31 is aimed at the hour numeral “12” within the day zone on the dial 40. Therefore, the time measured is 8:00 AM. In FIG. 5A, the hour hand 30 is aimed at the hour numeral “11” within the night zone on the dial 40, and the minute hand 31 is aimed at the hour numeral “12” within the night zone on the dial 40. Therefore, the time measured is 11:00 PM. In FIG. 5B, the hour hand 30 is aimed at the hour numeral “2” within the day zone on the dial 40, and the minute hand 31 is aimed at the hour numeral “6” at the right side between the day zone and the night zone on the dial 40. Therefore, the time measured is 2:30 PM. Because the indication of the hour numerals for minutes is same as conventional analog timepieces (hour numeral 3 for 15 minutes; hour numeral 6 for 30 minutes), the user can quickly be familiar with the indication of the present invention.

As indicated above, by means of adjusting the time counting of the second hand to match with day zone/night zone design and 24 hour numerals on the dial, the current time and day/night status are fully understood at a glance. Comparing to conventional analog timepieces, the invention saves the cost to provide a voice indication. Further, the invention reduces the motor driving time, therefore saving much electricity. The invention can be employed to a conventional analog timepiece by adding a dividing-by-2 dividing circuit to the electronic circuit and changing the dial.

A prototype of analog timepiece for full day indication has been constructed with the features of FIGS. 1˜5. The analog timepiece for full day indication functions smoothly to provide all of the features discussed earlier.

Although a particular embodiment of the invention has been described in detail for purposes of illustration, various modifications and enhancements may be made without departing from the spirit and scope of the invention.

What the invention claimed is:

1. An analog timepiece comprising a dial having a face, and hands turning on the face of said dial to indicate time, wherein said dial has equally spaced 24 marks marked on said face corresponding to 24 hours of a day, said 24 marks including a first series of 12 marks arranged in a day zone and a second series of 12 marks arranged in a night zone.

2. The analog timepiece as claimed in claim 1, wherein said 24 marks respectively correspond to a respective hour numeral.

3. The analog timepiece as claimed in claim 2, wherein the 12 marks of each of said first series of 12 marks and said second series of 12 marks respectively correspond to hour numerals 1 through 12.

4. The analog timepiece as claimed in claim 3, wherein the two marks corresponding to hour numeral 6 of said first series of 12 marks and said second series of 12 marks are respectively located at two distal ends of the horizontal axis of the face of said dial; the two marks corresponding to hour numeral 12 of said first series of 12 marks and said second series of 12 marks are respectively located at two distal ends of the vertical axis of the face of said dial.

5. The analog timepiece as claimed in claim 4, wherein said day zone covers the area of the face of said dial above said horizontal axis.

6. The analog timepiece as claimed in claim 5, wherein said day zone occupies one half of the whole area of the face of said dial.

7. The analog timepiece as claimed in claim 4, wherein said night zone covers the area of the face of said dial below said horizontal axis.

8. The analog timepiece as claimed in claim 7, wherein said night zone occupies one half of the whole area of the face of said dial.

9. An analog timepiece comprising a dial having a face, hands turning on the face of said dial to indicate time, and a clock hand driving unit that turns said hands on the face of said dial to indicate time, wherein said clock hand driving unit comprises a pulse generating unit adapted to output 0.5pulse/sec signal, and a motor controlled by said 0.5 pulse/sec signal to turn said hands on the face of said dial to indicate time.

10. The analog timepiece as claimed in claim 9, wherein said pulse generating unit comprises a pulse generator that generates 1 pulse/sec signal, and a dividing-by-2 dividing circuit electrically connected to said pulse generator and adapted to divide said 1 pulse/sec signal into said 0.5 pulse/sec signal.

11. The analog timepiece as claimed in claim 10, wherein said dividing-by-2 dividing circuit is comprised of a flip-flop and a logic device.

12. The analog timepiece as claimed in claim 11, wherein said flip-flop is a JK flip-flop.

13. An analog timepiece comprising a dial having a face, hands turning on the face of said dial to indicate time, and a clock hand driving unit that turns said hands on the face of said dial to indicate time, wherein said dial has equally spaced 24 marks marked on said face corresponding to 24 hours of a day, said 24 marks including a first series of 12 marks arranged in a day zone and a second series of 12 marks arranged in a night zone; said clock hand driving unit comprises a pulse generating unit adapted to output 0.5 pulse/sec signal, and a motor controlled by said 0.5 pulse/sec signal to turn said hands on the face of said dial to indicate time.

14. The analog timepiece as claimed in claim 13, wherein the 12 marks of each of said first series of 12 marks and said second series of 12 marks respectively correspond to hour numerals 1 through 12.

15. The analog timepiece as claimed in claim 14, wherein the two marks corresponding to hour numeral 6 of said first series of 12 marks and said second series of 12 marks are respectively located at two distal ends of the horizontal axis of the face of said dial; the two marks corresponding to hour numeral 12 of said first series of 12 marks and said second series of 12 marks are respectively located at two distal ends of the vertical axis of the face of said dial.

16. The analog timepiece as claimed in claim 15, wherein said day zone covers the area of the face of said dial above said horizontal axis and occupies one half of the whole area of the face of said dial.

17. The analog timepiece as claimed in claim 15, wherein said night zone covers the area of the face of said dial below said horizontal axis and occupies one half of the whole area of the face of said dial.

18. The analog timepiece as claimed in claim 13, wherein said pulse generating unit comprises a pulse generator that generates 1 pulse/sec signal, and a dividing-by-2 dividing circuit electrically connected to said pulse generator and adapted to divide said 1 pulse/sec signal into said 0.5 pulse/sec signal.

19. The analog timepiece as claimed in claim 18, wherein said dividing-by-2 dividing circuit is comprised of a flip-flop and a logic device.

20. The analog timepiece as claimed in claim 19, wherein said flip-flop is a JK flip-flop.
